(19) United States
(12) Patent Application Publication
(10) Pub. No.: US 2022/0383113 A1
(43) Pub. Date: Dec. 1, 2022

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Koji OKABE, Tokyo (JP); Takafumi KOSHINAKA, Tokyo (JP)

(73) Assignee: NEC Corporation, Minato-ku, Tokyo (JP)

(21) Appl. No.: 17/771,954

(22) PCT Filed: Nov. 12, 2019
(86) PCT No.: PCT/JP2019/044342

§ 371 Date: Apr. 26, 2022

(51) Int. Cl. G06N 3/08

(52) U.S. Cl. CPC G06N 3/08

(57) ABSTRACT

The information processing device is provided in a feature extraction block in a neural network. The information processing device acquires a local feature quantity group constituting one unit of information, and computes a weight corresponding to a degree of importance of each local feature quantity. Next, the information processing device computes a weighted statistic for a whole of the local feature quantity group using the computed weights, and deforms and outputs the local feature quantity group using the computed weighted statistic.

### TECHNICAL FIELD

The disclosure relates to a feature extraction method using a neural network.

### BACKGROUND ART

Recently, neural networks have been used in fields such as image recognition and speaker recognition. In these neural networks, features are extracted from inputted image data and voice data, and processing such as recognition and determination is performed based on the extracted feature quantities. In order to improve the discrimination performance in image recognition and speaker recognition, a technique for extracting features with high accuracy has been proposed. For example, Non-Patent Document 1 discloses a method of calculating a weight for each channel with respect to the local feature quantities of each position extracted from the image, based on an average of feature quantities of the entire image, and performing weighting.

### PRECEDING TECHNICAL REFERENCES

### Non-Patent Document

Non-Patent Document 1: J. Hu et al. “Squeeze-and-Excitation Networks” CVPR2018

### SUMMARY

### Problem to be Solved

However, in the method of Non-Patent Document 1, only an average is used as a feature quantity of an entire image, and there is room for improvement.

One object of the disclosure is to enable a feature extraction with high accuracy, in a neural network, using a statistic of global feature quantity of input data.

### Means for Solving the Problem

To solve the above problems, in one aspect of the disclosure, there is provided an information processing device comprising:

an acquisition unit configured to acquire a local feature quantity group constituting one unit of information;

a weight computation unit configured to compute a weight corresponding a degree of importance of each local feature quantity;

a weighted statistic computation unit configured to compute a weighted statistic for a whole of the local feature group using the computed weights; and

a feature quantity deformation unit configured to deform the local feature quantity group using the computed weighted statistic and output the local feature quantity group.

In another aspect of the disclosure, there is provided an information processing method comprising:

acquiring a local feature quantity group constituting one unit of information;

computing a weight corresponding a degree of importance of each local feature quantity;

computing a weighted statistic for a whole of the local feature group using the computed weights; and

deforming the local feature quantity group using the computed weighted statistic and outputting the local feature quantity group.

In still another aspect of the disclosure, there is provided a recording medium recording a program, the program causing a computer to execute:

acquiring a local feature quantity group constituting one unit of information;

computing a weight corresponding a degree of importance of each local feature quantity;

computing a weighted statistic for a whole of the local feature group using the computed weights; and

deforming the local feature quantity group using the computed weighted statistic and outputting the local feature quantity group.

### Effect

According to the disclosure, it is possible to perform a feature extraction with high accuracy in the neural network, by using weighted statistics of global feature quantity of input data.

### BRIEF DESCRIPTION OF THE DRAWINGS

FIG. 1 illustrates a hardware configuration of a feature quantity processing device according to an example embodiment.

FIG. 2 illustrates a functional configuration of the feature quantity processing device according to the example embodiment.

FIG. 3 is a flowchart of feature extraction processing.

FIG. 4 shows example of application of the feature quantity processing device to image recognition.

FIG. 5 shows an example of application of the feature quantity processing device to speaker recognition.

### EXAMPLE EMBODIMENTS

Preferred example embodiments of the disclosure will be described with reference to the accompanying drawings.

(Hardware Configuration)

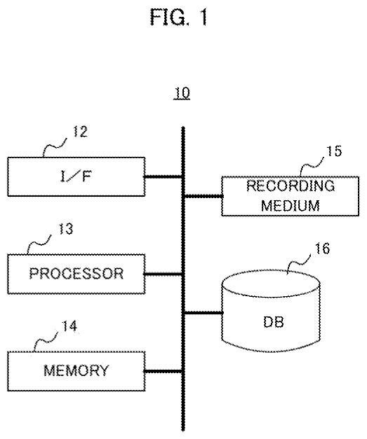

FIG. 1 is a block diagram illustrating a hardware configuration of a feature quantity processing device according to an example embodiment of the information processing device of the disclosure. As illustrated, the feature quantity processing device 10 includes an interface (I/F) 12, a processor 13, a memory 14, a recording medium 15, and a database (DB) 16.

The interface 12 performs input and output of data to and from external devices. Specifically, the interface 12 acquires input data to be subject to feature extraction from an external device. The interface 12 is an example of an acquisition unit of the disclosure.

The processor 13 is a computer such as a CPU (Central Processing Unit), or a CPU with a GPU (Graphics Processing Unit), and controls the feature quantity processing device 10 by executing a program prepared in advance. Specifically, the processor 13 executes feature extraction processing to be described later.

The memory 14 is composed of a ROM (Read Only Memory), a RAM (Random Access Memory), or the like. The memory 14 stores a model of a neural network used by the feature quantity processing device 10. The memory 14 is also used as a work memory during the execution of various processes by the processor 13.

The recording medium 15 is a non-volatile and non-transitory recording medium such as a disk-shaped recording medium or a semiconductor memory, and is configured to be detachable from the feature quantity processing device 10. The recording medium 15 records various programs to be executed by the processor 13. When the feature quantity processing device 10 executes various kinds of processing, a program recorded on the recording medium 15 is loaded into the memory 14 and executed by the processor 13. The database 16 stores data inputted through the interface 12.

(Functional Configuration)

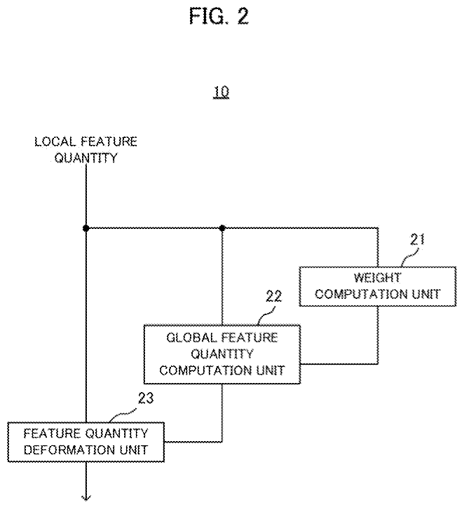

Next, a functional configuration of the feature quantity processing device will be described. FIG. 2 is a block diagram showing a functional configuration of the feature quantity processing device according to a first example embodiment. The feature quantity processing device 10 is introduced into a block for performing feature extraction from input data, for example, as a part of a neural network for performing processing such as image recognition or speaker recognition. As illustrated, the feature quantity processing device 10 includes a weight computation unit 21, a global feature quantity computation unit 22, and a feature quantity deformation unit 23.

A plurality of local feature quantities constituting information of one unit, i.e., a local feature quantity group is inputted to the feature quantity processing device 10. One unit of information is, for example, image data for one image, voice data by one utterance of a certain speaker, and the like. The local feature quantity is a feature quantity of a part of the input data (e.g., one pixel of the input image data) or a part of the feature quantity extracted from the input data (e.g., a part of the feature map obtained by the convolution of the image data). The local feature quantity is inputted to the weight computation unit 21 and the global feature quantity computation unit 22.

The weight computation unit 21 computes the degree of importance for the plurality of local feature quantities inputted, and computes the weight according to the degree of importance of each local feature quantity. The weight computation unit 21 sets a large weight for the local feature quantity having a high degree of importance among the plurality of local feature quantities, and sets a small weight for the local feature quantity having a low degree of importance. Incidentally, the degree of importance is for increasing the discernment of the local feature quantity outputted from the feature quantity deformation unit 23 to be described later. The computed weights are inputted to the global feature quantity computation unit 22.

The global feature quantity computation unit 22 computes the global feature quantity. Here, the global feature quantity is a statistic about the whole of the local feature quantity group. For example, in the case of image data, the global feature quantity is a statistic for the entire image. Specifically, the global feature quantity computation unit 22 computes a weighted statistic for the entire local feature quantity group using the weights inputted from the weight computation unit 21. Here, the statistic is an average, a standard deviation, a variance, etc., and the weighted statistic is the statistic calculated using the weight computed for each local feature quantity. For example, the weighted average is obtained by weighting and adding the local feature quantities and then calculating the average. The weighted standard deviation is obtained by calculating the standard deviation by weighted operation for each local feature quantity. Incidentally, the statistic of second or high-order, such as the standard deviation and the dispersion, is called “high-order statistic.” The global feature quantity computation unit 22 computes a weighted statistic by performing weighted operation of the statistics of the local feature quantity group using the weight for each local feature quantity computed by the weight computation unit 21. The weighted statistic thus computed is inputted to the feature quantity deformation unit 23. The global feature quantity computation unit 22 is an example of a weighted statistic computation unit of the disclosure.

The feature quantity deformation unit 23 deforms the local feature quantity based on the weighted statistic. For example, the feature quantity deformation unit 23 inputs the weighted statistic to the sub-neural network to obtain a weighted vector of the same dimension as the number of channels of the local feature quantity. Further, the feature quantity deformation unit 23 deforms the local feature quantity by multiplying the inputted local feature quantity by the weight vector computed for the local feature quantity group to which the local feature quantity belongs.

As described above, the feature quantity processing device 10 of the example embodiment computes the weights indicating the degree of importance for each local feature quantity, and performs the weighted operation of the local feature quantity using the weights thereby to compute the global feature quantity. Therefore, in comparison with the case of using mere averaging, it is possible to impart a high discernment to the local feature quantity by means of weighting by the degree of importance for increasing the discernment. As a result, it becomes finally possible to extract feature quantities with high discernment for the objective task.

(Feature Extraction Processing)

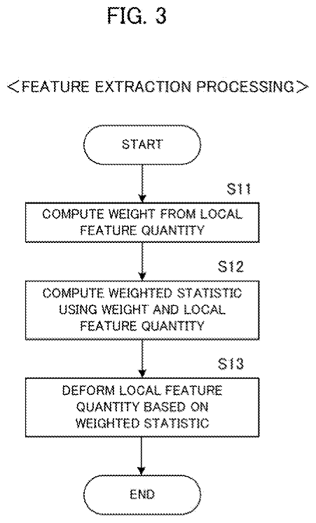

FIG. 3 is a flowchart of feature extraction processing using the feature quantity processing device 10 shown in FIG. 2. This processing is executed by the processor shown in FIG. 1, which executes a program prepared in advance and forms a neural network for feature extraction.

First, when the local feature quantity group is inputted, the weight computation unit 21 computes a weight indicating the degree of importance for each local feature quantity (Step S11). Next, the global feature quantity computation unit 22 computes the weighted statistic for the local feature quantity group as the global feature quantity using the weight for each local feature quantity (Step S12). Next, the feature quantity deformation unit 23 deforms the local feature quantity based on the computed weighted statistic (Step S13).

(Application Example to Image Recognition)

Next, description will be given of an example in which the feature quantity processing device of the example embodiment is applied to a neural network for performing image recognition. In the neural network for image recognition, feature extraction is carried out from input images using CNNs (Convolutional Neural Network) of plural stages. The feature quantity processing device of the example embodiment can be disposed between the CNNs of plural stages.

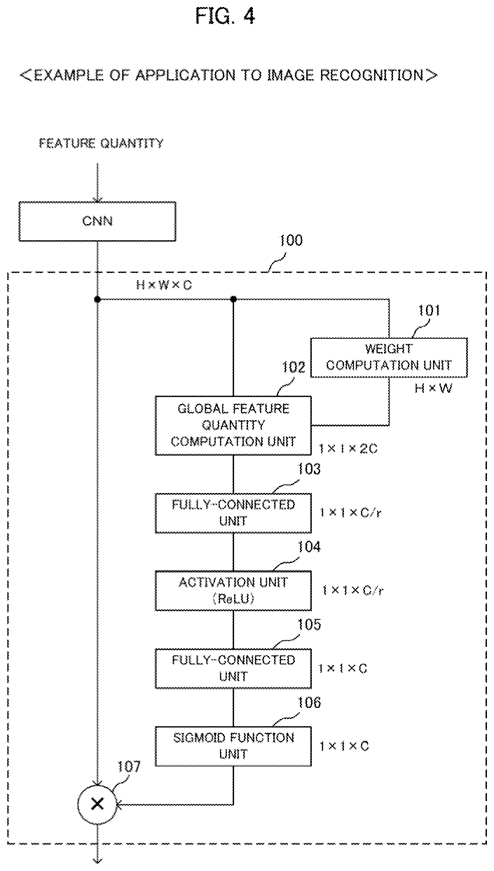

FIG. 4 shows an example in which the feature quantity processing device 100 of the example embodiment is disposed at a subsequent stage of the CNN. Note that this feature quantity processing device 100 has a configuration based on an SE (Squeeze-and-Excitation) block described in Non-Patent Document 1. As illustrated, the feature quantity processing device 100 includes a weight computation unit 101, a global feature quantity computation unit 102, a fully-connected unit 103, an activation unit 104, a fully-connected unit 105, a sigmoid function unit 106, and a multiplier 107.

From the CNN, three-dimensional local feature quantity group of H×W×C is outputted. Here, “H” is the number of pixels in the vertical direction, “W” is the number of pixels in the horizontal direction, and “C” is the number of channels. The weight computation unit 101 receives the three-dimensional local feature quantity group, computes the weight for each local feature quantity, and inputs the weight to the global feature quantity computation unit 102. In this example, the number of the weights computed by the weight computation unit 101 is (H×W). The global feature quantity computation unit 102 computes the weighted statistic of each channel of the local feature quantity group inputted from the CNN using the weights inputted from the weight computation unit 101. For example, the global feature quantity computation unit 102 computes the weighted average and the weighted standard deviation for each channel, combines the two and inputs it to the fully-connected unit 103.

The fully-connected unit 103 uses the reduction ratio “r” to reduce the inputted weighted statistic to the C/r dimension. The activation unit 104 applies a ReLU (Rectified Linear Unit) function to the dimensionally-reduced weighted statistic, and the fully-connected unit 105 return the weighted statistic to the C-dimension. Then, the sigmoid function unit 106 converts the weighted statistic to a value of “0” to “1” by applying the sigmoid function to the weighted statistic. The multiplier 107 multiplies each local feature quantity outputted from the CNN by the converted value. Thus, by using the statistics computed using the weight of each pixel constituting one channel, the feature quantity of the channel is deformed.

(Application Example to Speaker Recognition)

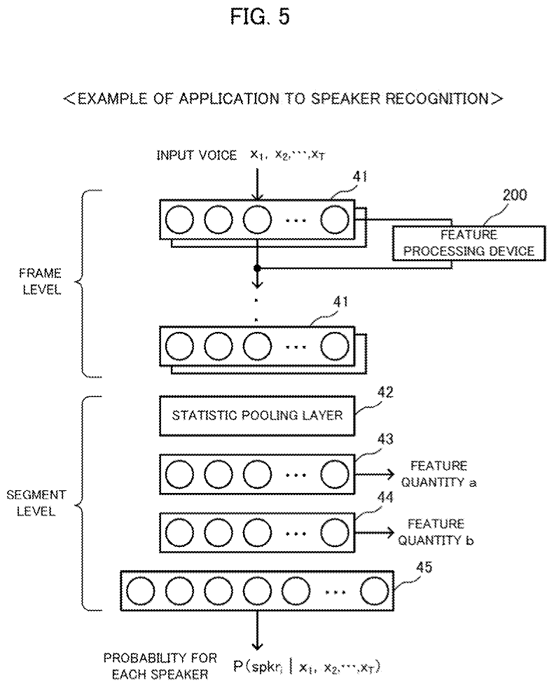

FIG. 5 shows an example in which the feature quantity processing device of this example embodiment is applied to a neural network for speaker recognition. Hereafter, the input voice corresponding to one utterance of the speaker is referred to as one-segment input voice. The one-segment input voice is divided into a plurality of frames “1” to “T” corresponding to each time, and the input voice x₁˜x_{T} for each frame is inputted to the input layer.

The feature quantity processing device 200 of the example embodiment is inserted between the feature extraction layers 41 that perform feature extraction at the frame level. The feature quantity processing device 200 receives the feature quantity outputted from the feature extraction layer 41 at the frame level and computes a weight indicating the degree of importance of the feature quantity for each frame. Then, the feature quantity processing device 200 computes the weighted statistic for the entire plurality of frames using the weights, and applies the weighted statistic to the feature quantity for each frame outputted from the feature extraction layer 41. Since the plurality of feature extracting layers 41 at the frame level are provided, the feature quantity processing device 200 can be applied to any of the feature extracting layers 41.

The statistic pooling layer 42 integrates the feature quantities outputted from the final layer of the frame level to a segment level and computes its average and standard deviation. The segment-level statistic generated by the statistic pooling layer 42 is sent to the later hidden layer and then to the final output layer 45 using a Softmax function. The layers 43 and 44 before the final output layer 45 may output the feature quantity in a segment unit. Using the outputted feature quantity of the segment unit, determination of the identity of the speaker or the like becomes possible. Also, the final output layer 45 outputs a probability P that the input voice of each segment corresponds to each of plural speakers (i-persons) assumed in advance.

### Other Application Examples

Although the above description is directed to the examples in which the feature quantity processing device of the example embodiment is applied to image processing and speaker recognition, the example embodiment can be applied to various identification and verification tasks in which voice is inputted, such as language identification, gender identification, and age estimation, other than the above examples. Further, the feature quantity processing device of the example embodiment can be applied not only to the case of inputting voice but also to the task of inputting time series data such as biological data, vibration data, weather data, sensor data, and text data.

### Modification

Although a weighted standard deviation is used as a weighted high-order statistic in the above example embodiment, a weighted variance using variance which is a second-order statistic, a weighted covariance indicating correlations between elements having different local feature quantities, and the like may be used. In addition, a weighted skewness (skewness) which is a third-order statistic, or a weighted kurtoticity (kurtosis) which is a fourth-order statistic, may be used.

A part or all of the example embodiments described above may also be described as the following supplementary notes, but not limited thereto.

(Supplementary Note 1)

An information processing device comprising:

an acquisition unit configured to acquire a local feature quantity group constituting one unit of information;

a weight computation unit configured to compute a weight corresponding a degree of importance of each local feature quantity;

a weighted statistic computation unit configured to compute a weighted statistic for a whole of the local feature group using the computed weights; and

a feature quantity deformation unit configured to deform the local feature quantity group using the computed weighted statistic and output the local feature quantity group.

(Supplementary Note 2)

The information processing device according to Supplementary note 1, wherein the weighted statistic is a weighted high-order statistic using a high-order statistic.

(Supplementary Note 3)

The information processing device according to Supplementary note 2, wherein the weighted high-order statistic comprises any one of a weighted standard deviation, a weighted variance, a weighted skewness and a weighted kurtosis.

(Supplementary Note 4) The information processing device according to any one of Supplementary notes 1 to 3, wherein the feature quantity deformation unit multiplies the local feature quantity by the weighted statistic or a value computed based on the weighted statistic.

(Supplementary Note 5)

The information processing device according to any one of Supplementary notes 1 to 4, wherein the information processing device is configured using a neural network.

(Supplementary Note 6)

The information processing device according to any one of Supplementary notes 1 to 5,

wherein the information processing device is provided in a feature extracting unit in an image recognition device, and

wherein the local feature quantity is a feature quantity extracted from an image inputted to the image recognition device.

(Supplementary Note 7)

The information processing device according to any one of Supplementary notes 1 to 5,

wherein the information processing device is provided in a feature extracting unit in a speaker recognition device, and

wherein the local feature quantity is a feature quantity extracted from a voice inputted to the speaker recognition device.

(Supplementary Note 8)

An information processing method comprising:

acquiring a local feature quantity group constituting one unit of information;

computing a weight corresponding a degree of importance of each local feature quantity;

computing a weighted statistic for a whole of the local feature group using the computed weights; and

deforming the local feature quantity group using the computed weighted statistic and outputting the local feature quantity group.

(Supplementary Note 9)

A recording medium recording a program, the program causing a computer to execute:

acquiring a local feature quantity group constituting one unit of information;

computing a weight corresponding a degree of importance of each local feature quantity;

computing a weighted statistic for a whole of the local feature group using the computed weights; and

deforming the local feature quantity group using the computed weighted statistic and outputting the local feature quantity group.

While the disclosure has been described with reference to the example embodiments and examples, the disclosure is not limited to the above example embodiments and examples. Various changes which can be understood by those skilled in the art within the scope of the disclosure can be made in the configuration and details of the disclosure.

### DESCRIPTION OF SYMBOLS

10, 100, 200 Feature quantity processing device
21, 101 Weight computation unit
2, 102 Global feature quantity computation unit
23 Feature quantity deformation unit

What is claimed is:

1. An information processing device comprising:
a memory configured to store instructions; and
one or more processors configured to execute the instructions to:
acquire a local feature quantity group constituting one unit of information;
compute a weight corresponding a degree of importance of each local feature quantity;
compute a weighted statistic for a whole of the local feature group using the computed weights; and
deform the local feature quantity group using the computed weighted statistic and output the local feature quantity group.

2. The information processing device according to claim 1, wherein the weighted statistic is a weighted high-order statistic using a high-order statistic.

3. The information processing device according to claim 2, wherein the weighted high-order statistic comprises any one of a weighted standard deviation, a weighted variance, a weighted skewness and a weighted kurtosis.

4. The information processing device according to claim 1, wherein the feature quantity deformation unit multiplies the local feature quantity by the weighted statistic or a value computed based on the weighted statistic.

5. The information processing device according to claim 1, wherein the information processing device is configured using a neural network.

6. The information processing device according to claim 1,
wherein the information processing device is provided in a feature extracting unit in an image recognition device, and
wherein the local feature quantity is a feature quantity extracted from an image inputted to the image recognition device.

7. The information processing device according to claim 1,
wherein the information processing device is provided in a feature extracting unit in a speaker recognition device, and
wherein the local feature quantity is a feature quantity extracted from a voice inputted to the speaker recognition device.

8. An information processing method comprising:
acquiring a local feature quantity group constituting one unit of information;
computing a weight corresponding a degree of importance of each local feature quantity;
computing a weighted statistic for a whole of the local feature group using the computed weights; and
deforming the local feature quantity group using the computed weighted statistic and outputting the local feature quantity group.

9. A non-transitory computer-readable recording medium recording a program, the program causing a computer to execute:
acquiring a local feature quantity group constituting one unit of information;
computing a weight corresponding a degree of importance of each local feature quantity;
computing a weighted statistic for a whole of the local feature group using the computed weights; and
deforming the local feature quantity group using the computed weighted statistic and outputting the local feature quantity group.
